(19) United States
(12) Patent Application Publication
(10) Pub. No.: US 2022/0155488 A1
(43) Pub. Date: May 19, 2022

(54) OPTICAL COMPONENT, IMAGE DISPLAY DEVICE USING SAME, AND HEAD-UP DISPLAY

(71) Applicant: KYOCERA Corporation, Kyoto-shi, Kyoto (JP)

(72) Inventors: Motohiro UMEHARA, Yasu-shi, Shiga (JP); Satoru TSUBOKURA, Omihachiman-shi, Shiga (JP); Mitsuhiro KAJIHARA, Higashiomi-shi, Shiga (JP); Yoshinori KUBO, Omihachiman-shi, Shiga (JP)

(21) Appl. No.: 17/426,128

(22) PCT Filed: Jan. 24, 2020
(86) PCT No.: PCT/JP2020/002599

§ 371 Date: Jul. 28, 2021

(30) Foreign Application Priority Data
Jan. 31, 2019 (JP) 2019-015141

(51) Int. Cl. G02B 1/02; G02B 5/22; G02B 27/01; G02B 5/30

(52) U.S. Cl. CPC G02B 1/02; G02B 5/30; G02B 27/0101; G02B 5/22

(57) ABSTRACT

An optical component according to the present disclosure includes a substrate, which contains sapphire and includes a first main face and a second main face on opposite sides from each other. The inclination of the first main face and of the second main face with respect to a c-plane of the sapphire is 15° or less, and a heat dissipating portion is provided on at least one of the first main face or the second main face.

### TECHNICAL FIELD

The present invention relates to an optical component used in an optical device such as an image display device, an image display device using the optical component, and a head-up display.

### BACKGROUND ART

An image display device, such as a projector device (a PJ device) and a head-up display device (a HUD device), is a device that uses a light source and various optical elements to irradiate a wall, a screen, a window, or the like with image information displayed on an image forming unit such as a liquid crystal panel, and causes a user to visually recognize the image information. Various optical components are provided in such an image display device. Examples of the optical components include a lens, a fluorescent plate on which a phosphor is disposed, a polarizing plate, and a sealing glass that seals liquid crystals.

Patent Document 1 describes a HUD device that is for use in a vehicle and that is provided with a display element including liquid crystal cells between an incidence-side polarizing member and an emission-side polarizing member, and a light source that irradiates the display element with light. The HUD device projects and displays, on a display member provided within a front visual field of a driver, a display image that has been transmitted through the display element. The HUD device that is for use in a vehicle and that is described in Patent Document 1 is provided with a heat transfer member (a quartz heat dissipating plate) that is disposed on an optical path of the display image, between the liquid crystal cell and the display member, transmits the display image, and is in contact with the emission-side polarizing member, and is provided with a holding member that is formed from a metal material and holds the heat transfer member.

### CITATION LIST

Patent Document
Patent Document 1: JP 2005-313733 A

### SUMMARY

An optical component according to the present disclosure is provided with a substrate containing sapphire and includes a first main face and a second main face on opposite sides from each other. The inclination of the first main face and the second main face with respect to a c-plane of the sapphire is 15° or less. A heat dissipating portion is provided on at least one of the first main face or the second main face.

An image display device according to the present disclosure includes a light source, and the above-described optical component positioned on an optical path of light emitted from the light source. Furthermore, a head-up display according to the present disclosure includes this image display device, and a display unit on which an image is displayed.

### BRIEF DESCRIPTION OF DRAWINGS

FIG. 1 is a schematic diagram illustrating an image display device that uses an optical component according to an embodiment of the present disclosure.

FIG. 2(A) is an explanatory diagram for describing the optical component according to the embodiment of the present disclosure, and FIG. 2(B) is an explanatory diagram of the optical component according to the embodiment of the present disclosure as viewed from a direction of an arrow A illustrated in FIG. 2(A).

FIG. 3 is an explanatory diagram illustrating a crystalline structure of sapphire.

FIG. 4 is an explanatory diagram illustrating a case in which the optical component according to the embodiment of the present disclosure is a polarizing plate, in which FIG. 4(A) illustrates a plan view and FIG. 4(B) illustrates a side view.

FIG. 5 is an explanatory diagram illustrating a case in which an optical component according to another embodiment of the present disclosure is a polarizing plate, in which FIG. 5(A) illustrates a plan view and FIG. 5(B) illustrates a cross-sectional view.

### DESCRIPTION OF EMBODIMENTS

An optical component used in an image display device such as a HUD device is required to have improved heat transfer and heat dissipation to the outside. In recent years, such a requirement has been getting stronger in image display devices in which the density and resolution of displayed images have been increasing. In the present specification, an “optical component” refers to a functional component that controls the intensity, color (wavelength), phase, polarization, or direction of incident light. Examples of such an optical component include a fluorescent plate, a wavelength filter, a wave plate, a polarizing plate, a mirror, and a lens.

An optical component of the present disclosure is provided with a substrate containing sapphire and includes a first main face and a second main face on opposite sides from each other. The inclination of the first main face and the second main face with respect to a c-plane of the sapphire is 15° or less. A heat dissipating portion is provided on at least one of the first main face or the second main face. In the optical component of the present disclosure, the inclination of the first main face and the second main face with respect to the c-plane of the sapphire is 15° or less, which is relatively small, and a thickness direction of the substrate approximately coincides with a c-axis direction of the sapphire. The sapphire has a high thermal conductivity in a direction parallel to the c-axis, and this is advantageous for heat transfer in the thickness direction of the substrate. Furthermore, by providing the heat dissipating portion on at least one of the first main face or the second main face, heat can be efficiently dissipated in the thickness direction of the substrate, which is the direction in which thermal conductivity is high.

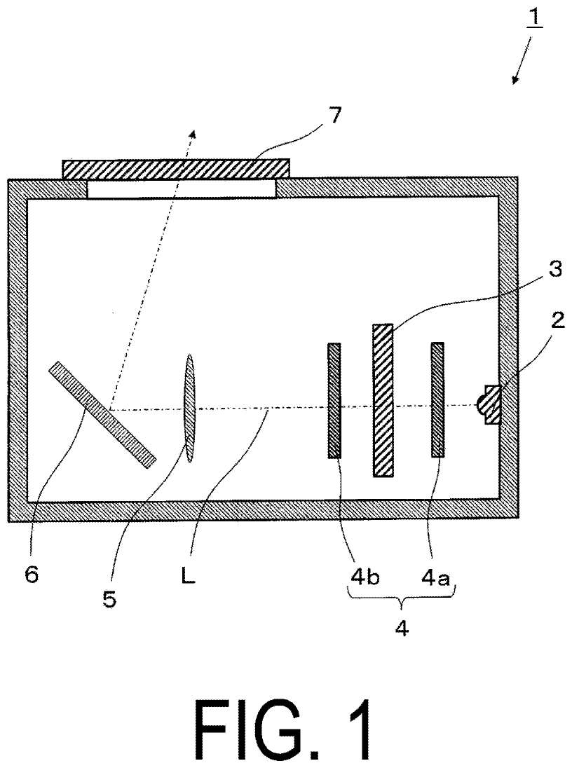

An optical component according to an embodiment of the present disclosure will be described with reference to FIGS. 1 to 4. FIG. 1 illustrates an image display device (HUD device) 1 provided with the optical component according to the embodiment of the present disclosure. The image display device 1 illustrated in FIG. 1 includes a light source 2, an image forming unit 3, a polarizing plate 4, a lens 5, a mirror 6, and an emission window 7. Of the members forming the image display device 1, the image forming unit 3, the polarizing plate 4, and the lens 5 correspond to the optical component in the present specification. When the emission window 7 has the function of an optical filter for cutting infrared light, the emission window 7 also corresponds to the optical component, for example. Then, at least one of these optical components (the polarizing plate 4, for example) is an optical component 4′ according to the embodiment of the present disclosure. Details of the image display device (HUD device) 1 will be described later.

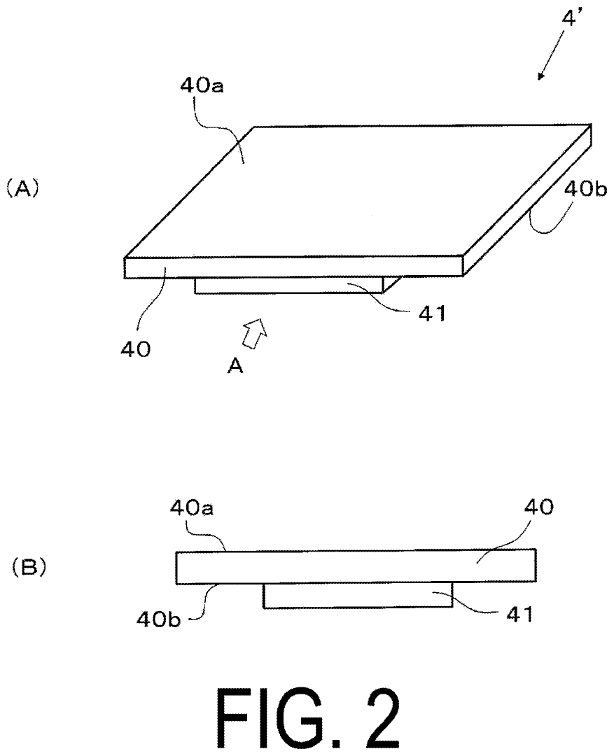

The optical component 4′ according to the embodiment is provided with a substrate 40 containing sapphire, and includes a first main face 40a and a second main face 40b on opposite sides from each other, as illustrated in FIG. 2. An example of the substrate 40 containing the sapphire is a sapphire substrate. Sapphire is a single crystal of aluminum oxide (Al₂O₃). Sapphire has excellent thermal resistance, thermal conductivity, and heat dissipation, and also has properties that can suppress an increase in temperature. The thickness of the substrate 40 is not limited. In order to satisfy mechanical strength and heat dissipation in a balanced manner, the substrate 40 may have a thickness from approximately 0.1 mm to approximately 15 mm.

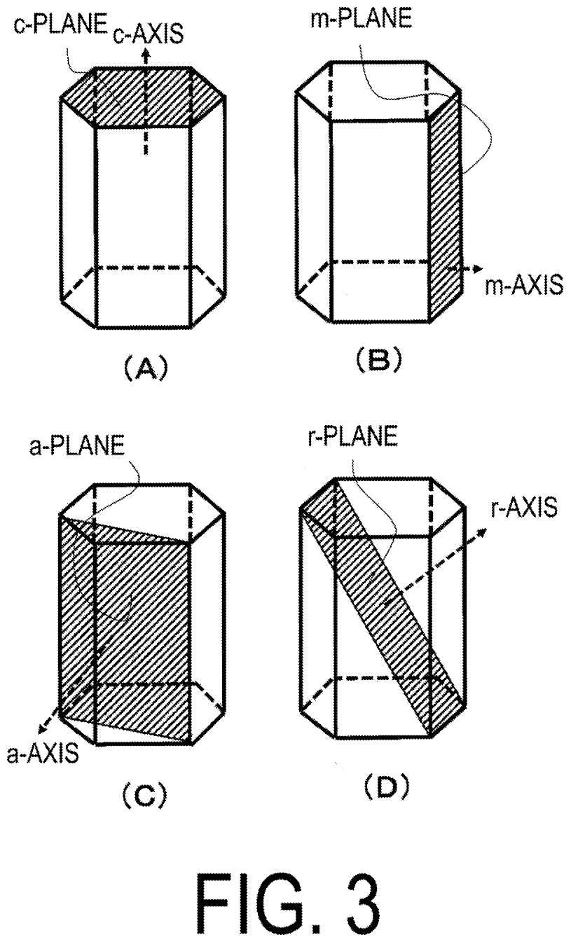

In the substrate 40, the inclination of the first main face 40a and the second main face 40b with respect to the c-plane of the sapphire is 15° or less. Here, crystal planes of the sapphire are described. FIG. 3 illustrates the crystalline structure of the sapphire. As illustrated in FIGS. 3(A) to (D), the sapphire has a hexagonal crystalline structure, and c-, m-, a-, and r-planes are present as representative crystal planes. Axes perpendicular to these planes are referred to as a c-axis, an m-axis, an a-axis, and an r-axis, respectively.

“The inclination of the first main face 40a and the second main face 40b with respect to the c-plane of the sapphire is 15° or less” indicates that, for example, when obtaining the substrate 40 by machining a sapphire ingot, the first main face 40a and the second main face 40b of the substrate 40 are substantially parallel with the c-plane illustrated in FIG. 3(A). In other words, the first main face 40a and the second main face 40b of the substrate 40 need not necessarily be machined to be in parallel with the c-plane illustrated in FIG. 3(A), and surfaces for which an angle formed with the c-plane of the sapphire is 15° or less may be the first main face 40a and the second main face 40b of the substrate 40. In the substrate 40, the inclination of the first main face 40a and the second main face 40b with respect to the c-plane of the sapphire may be 5° or less. When the first main face 40a (the second main face 40b) is a curved surface, in a cross-sectional view in the thickness direction of the substrate 40, an angle formed by a plane approximated to the curved surface and the c-plane may be 15° or less. The approximate plane is, for example, a least squares plane that is determined by the least squares method.

As illustrated in FIG. 2, in the optical component 4′ according to the embodiment, a heat dissipating portion 41 is provided on the second main face 40b of the substrate 40. In the HUD device 1 or the like provided with the optical component 4′, the heat dissipating portion 41 is used to efficiently dissipate heat generated when the device 1 is operated, heat received from outside of the device 1, and the like. The thermal conductivity of the sapphire is higher in a direction parallel to the c-axis than a direction orthogonal to the c-axis. Thus, heat is easily transferred in the c-axis direction (the thickness direction of the substrate 40), and is dissipated through the heat dissipating portion 41 provided on at least one of the first main face 40a or the second main face 40b.

An aspect of the heat dissipating portion 41 is not particularly limited. A portion having a smaller heat resistance than that of a portion of the substrate 40 other than the heat dissipating portion 41, or a portion in which heat dissipation is promoted as a result of being cooled by an external cooling mechanism is referred to as a “heat dissipating portion”. For example, the “heat dissipating portion” is a portion in which the surface area per unit projection area is larger, the surface roughness is larger, or the thermal conductivity is larger than that of a portion of the substrate 40 other than the heat dissipating portion 41, or a portion against which cooling air from the outside is blown. A portion of a main face in which a metal material (such as a metal foil) or the like is disposed may be formed as the heat dissipating portion 41, or at least a portion of the main face may be machined to be a portion against which the air is more likely to be blown, or to be a portion which is more likely to come into contact with the air, in order to form the heat dissipating portion 41. Alternatively, in order to increase the surface area or the surface roughness, fine lines, protrusions and depressions, or the like may be formed in the main face to form the heat dissipating portion 41.

From the viewpoint of being able to be disposed in an optical path, the heat dissipating portion 41 described above preferably has a size and a shape that do not cause transmittance of light from the light source 2 to be reduced, such as a size and a shape that cause reflectance of the incident light to be reduced, for example. A region, of the sapphire itself, in which thermal conductivity has been improved, for example, by replacing some of the oxygen in the sapphire with nitrogen, may be formed as the heat dissipating portion 41. Examples of a nitride of aluminum obtained as a result of replacing some of the oxygen in the sapphire with nitrogen include aluminum nitride and aluminum oxynitride. Aluminum oxynitride is a compound or solid solution containing oxygen, nitrogen, and aluminum as constituent elements. Aluminum nitride and aluminum oxynitride can be used as the heat dissipating portion 41 since the thermal conductivity thereof is greater than that of aluminum oxide. Aluminum nitride and aluminum oxynitride may be crystalline or amorphous, and the higher the crystallinity, the higher the thermal conductivity. Furthermore, when a single crystal is used, since there is no crystalline interface, the transmittance of light is high, and it can thus be disposed on the optical path. When the heat dissipating portion 41 is formed from a material through which light is not easily transmitted, such as a metal, or formed in a shape through which light is not easily transmitted, the heat dissipating portion 41 is preferably disposed in a region that does not obstruct the optical path.

A functional portion is provided on at least one of the first main face 40a or the second main face 40b of the substrate 40 that is on the opposite side from the heat dissipating portion 41. In the present specification, the “functional portion” means a function that controls or a portion that reinforces the intensity, color, phase, polarization, or direction of the incident light, a function that refracts the incident light, or the like. Specific examples of the functional portion include an optical filter that transmits or absorbs a part of the incident light, an anti-reflection film, a reflective film, a phosphor, and a color wheel. One type of such a functional portion may be provided on at least one of the first main face 40a or the second main face 40b, or two or more types of the functional portion may be provided.

Examples of the optical filter include an optical filter that transmits or absorbs light in a specific wavelength range (an IR cutting film, or the like), and an optical filter that transmits or absorbs light in a specific polarization direction (liquid crystals, a polarizer, or the like). Furthermore, the reflective film also includes a dichroic film that transmits light having a specific wavelength and reflects light having other wavelengths.

When the functional portion is provided on the first main face 40a, the heat dissipating portion 41 is preferably provided on the second main face 40b. In general, the optical component 4′ generates heat at the functional portion. When the functional portion and the heat dissipating portion 41 are provided on the main faces on opposite sides from each other, a separation distance between the functional portion and the heat dissipating portion 41 is easily reduced. Then, when the first main face 40a and the second main face 40b are substantially parallel with the c-plane, that is, when the thickness direction of the substrate 40 is substantially parallel with the c-axis, heat is easily transferred in the thickness direction of the substrate 40, and is easily dissipated through the heat dissipating portion 41.

When two or more types of the functional portion are provided on the first main face 40a and the second main face 40b, the functional portion having the largest calorific value (which may also be referred to as a first functional portion) is preferably provided on the first main face 40a, and the heat dissipating portion 41 is preferably provided on the second main face 40b. When the first main face 40a and the second main face 40b are substantially parallel with the c-plane, that is, when the thickness direction of the substrate 40 is substantially parallel with the c-axis, heat is easily transferred in the thickness direction of the substrate 40, and heat of the first functional portion is easily dissipated through the heat dissipating portion 41.

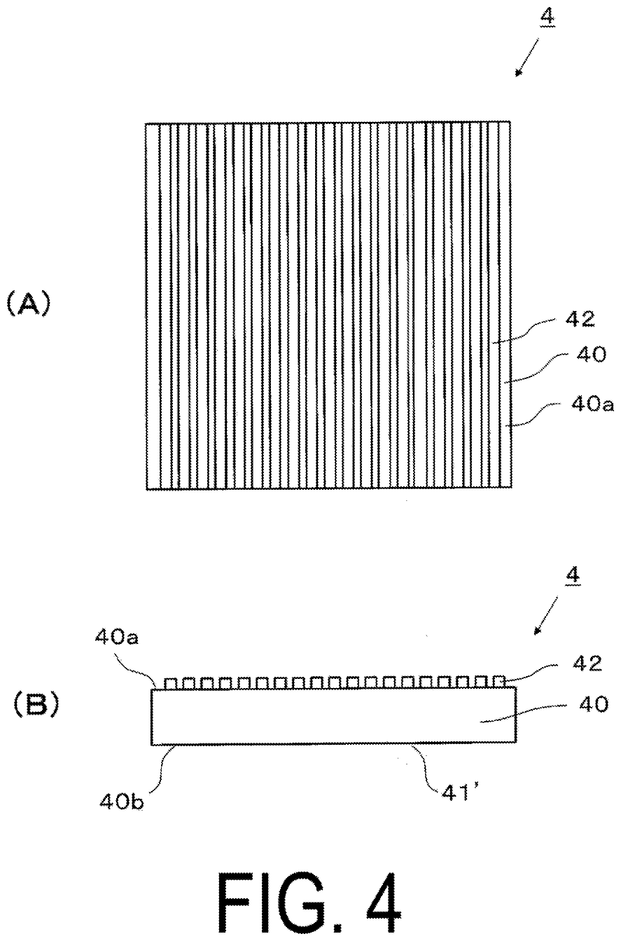

The functional portion will be specifically described using, as an example, a case in which the optical component 4′ according to the embodiment is the polarizing plate 4. As illustrated in FIGS. 4(A) and 4(B), the polarizing plate 4 includes the substrate 40, a polarizer 42 formed on the first main face 40a of the substrate 40, and the heat dissipating portion 41 provided on the second main face 40b of the substrate 40. For example, the polarizer 42 has a structure in which a plurality of thin metal wires are aligned having gaps therebetween.

The thin metal wires are not particularly limited as long as they are formed from a metal, and examples of the metal include aluminum, copper, gold, silver, and alloys thereof. The thin metal wires are formed in the following manner, for example.

First, the first main face 40a of the substrate 40 is covered with a metal film using a film forming method such as a vapor deposition method or a sputtering method, for example. Next, a resist film is applied to the surface of the metal film, and exposed and developed to form a resist pattern. Next, etching processing is performed on the metal film using an etchant so that the metal film is etched in a striped pattern having a constant gap between the stripes. Next, by removing the resist pattern and performing cleaning, thin metal wires can be formed on the first main face 40a of the substrate 40.

Each of the thin metal wires has a thickness of from approximately 50 nm to approximately 500 nm, and has a width of from approximately 30 nm to approximately 150 nm. By setting the width of the gap between the thin metal wires to be shorter than the wavelength of transmitted light, the transmitted light can be converted to linearly polarized light, and a function as the polarizing plate 4 is realized. The width of the gap between the thin metal wires is normally from approximately 60 nm to approximately 300 nm.

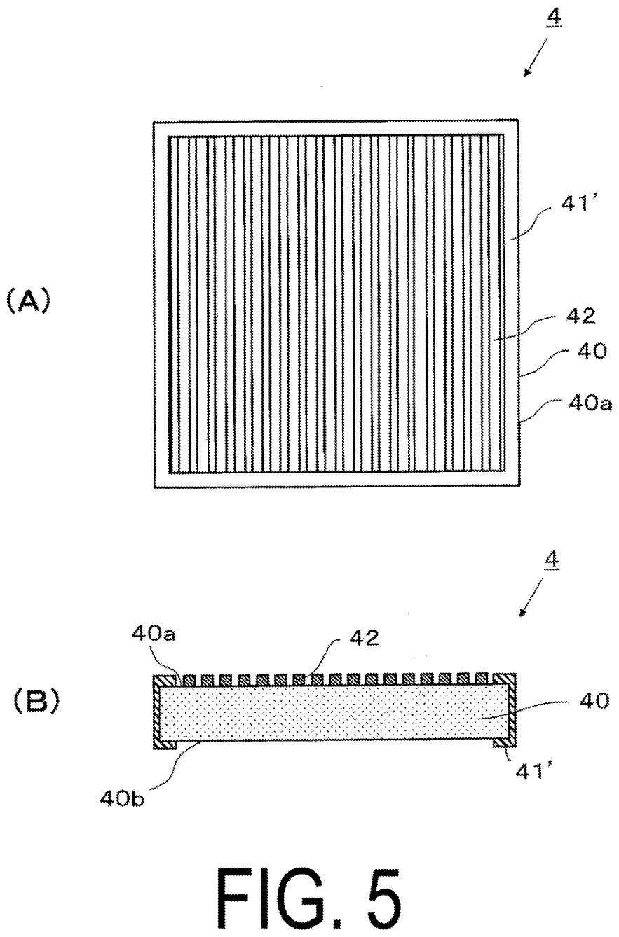

As with the optical component 4′ (the polarizing plate 4) of an aspect illustrated in FIG. 4, when the first functional portion is provided on the first main face 40a, the heat dissipating portion 41 may be formed on the second main face 40b (a first aspect). In this case, the surface roughness (an arithmetic mean roughness Ra, for example) of a portion or all of the second main face 40b may be larger than the surface roughness of the first main face 40a. By making the surface area of the second main face 40b relatively large, at least a portion of the second main face 40b can be formed as a heat dissipating portion 41′ that is advantageous for heat dissipation to the outside. In this case, the heat dissipating portion 41′ may be positioned on the optical path (including a central portion of the second main face 40b in a plan view). Even if the surface roughness is made slightly larger, no practical problem arises as long as the surface roughness is within a range that satisfies the optical characteristics (transmittance, for example) of the optical component 4′. Another aspect of the heat dissipating portion may be an aspect in which an opaque separate body such as a metal member is attached to the substrate 40 as the heat dissipating portion 41′ (a second aspect). An example of this aspect is illustrated in FIG. 5.

A frame is attached to the polarizing plate 4 illustrated in FIG. 5 so that a portion of the frame is in contact with the outer periphery of the second main face 40b. In the polarizing plate 4 illustrated in FIG. 5, this frame acts as the heat dissipating portion 41′, and the heat dissipating portion 41′ is positioned outside the optical path. Heat generated by the functional portion positioned on the first main face 40a is efficiently conducted in the thickness direction of the substrate 40 toward the second main face 40b side, and dissipated to the outside. This heat dissipation is further promoted by the heat dissipating portion 41′. In this case, for example, as illustrated in FIG. 5, the heat dissipating portion 41′ may be in contact with a section extending from an outer peripheral portion of the second main face 40b to side surfaces of the substrate, and may further be in contact with the outer periphery of the first main face 40a.

The optical component 4′ according to the embodiment can also be used as the lens 5. When the optical component 4′ is used as the lens 5, the substrate 40 may be machined to be a concave lens or a convex lens. When the optical component 4′ is used as the lens 5, the heat dissipating portion 41 is provided, for example, outside the optical path of the second main face 40b so as not to obstruct the optical path.

The optical component 4′ according to the embodiment is used, for example, as a member of the image display device 1 along with the light source 2. As described above, in the image display device (HUD device) 1 illustrated in FIG. 1, the polarizing plate 4 and the lens 5 correspond to the optical component 4′ according to the embodiment. Further, when the emission window 7 includes an IR cutting film as the functional portion, the emission window 7 corresponds to the optical component 4′ according to the embodiment. Hereinafter, the image display device 1 according to the embodiment of the present disclosure will be specifically described using a case, as an example, in which the image display device 1 is the HUD device 1 illustrated in FIG. 1. As described above, the HUD device 1 illustrated in FIG. 1 includes the light source 2, the image forming unit 3, the polarizing plate 4, the lens 5, the mirror 6, and the emission window 7. Two types of the polarizing plate 4, namely, an incidence-side polarizing plate 4a and an emission-side polarizing plate 4b are used.

In the HUD device 1 illustrated in FIG. 1, the incidence-side polarizing plate 4a, the image forming unit 3, the emission-side polarizing plate 4b, the lens 5, and the mirror 6 are arranged in this order from the side closer to the light source 2. In FIG. 1, an emission optical path L of image light including emitted light from the light source 2 is indicated by a dashed line arrow.

Of the polarizing plates 4, the incidence-side polarizing plate 4a is used to polarize light from the light source 2 and cause the light to enter the image forming unit 3. The heat dissipation of the incidence-side polarizing plate 4a can be further improved by forming the polarizer 42 from a material having a higher thermal conductivity than the sapphire (aluminum, copper, or the like, for example). Examples of the image forming unit 3 include a liquid crystal panel formed of twisted nematic liquid crystal (TN liquid crystal), or the like.

Of the polarizing plates 4, the emission-side polarizing plate 4b is used to block polarization, of the image light emitted from the image forming unit 3, in a direction that is not necessary for image display. The heat dissipation of the emission-side polarizing plate 4b can also be further improved by forming the polarizer 42 from a material having a higher thermal conductivity than that of the sapphire (aluminum, copper, or the like, for example). A combination of the polarization directions of the incidence-side polarizing plate 4a and the emission-side polarizing plate 4b is appropriately set in accordance with the type of the image forming unit 3. For example, when the TN liquid crystal is used as the image forming unit 3, the incidence-side polarizing plate 4a and the emission-side polarizing plate 4b are disposed with the polarization directions thereof rotated by 90° with respect to each other.

The image light transmitted through the emission-side polarizing plate 4b is incident on the lens 5. When the HUD device 1 is provided with the lens 5, the image light can be magnified. In order to magnify the image light, the lens 5 is a convex lens. The image light magnified by the lens 5 is reflected by the mirror 6 and projected onto a display unit (a screen) provided outside the HUD device 1, via the emission window 7. Examples of the display unit include a glass and a screen. When the HUD device 1 is used as the HUD device 1 for use in a vehicle, examples of the display unit include a windscreen, a rear glass, and a window of an automobile.

As described above, in the optical component 4′ according to the embodiment, the inclination of the first main face 40a and the second main face 40b with respect to the c-plane of the sapphire is 15° or less, which is relatively small, and the thickness direction of the substrate 40 approximately coincides with the c-axis direction of the sapphire. The sapphire has a high thermal conductivity with respect to a direction parallel to the c-axis, and this is advantageous for heat transfer in the thickness direction of the substrate. Furthermore, by providing the heat dissipating portion 41 on at least one of the first main face 40a or the second main face 40b, heat dissipation can be efficiently performed in the thickness direction of the substrate 40, which is the direction in which the thermal conductivity is high.

Since the optical component 4′ has excellent heat dissipation, the image display device 1 provided with the optical component 4′ according to the embodiment as one type of a member thereof can be used under conditions in which the temperature gets relatively high. Examples of the image display device 1 used under such high temperature conditions include the image display device 1 mounted on a moving body such as a vehicle, a train, a ship, an aircraft, and the like, and the image display device 1 used outdoors, and is the HUD device 1 for use in a vehicle, for example.

The optical component of the present disclosure is not limited to the optical component 4′ according to the embodiment described above. The substrate 40 used in the optical component 4′ according to the embodiment has a quadrangular shape. However, the shape of the substrate 40 used in the optical component of the present disclosure is set as appropriate, for example, in accordance with its application or the like, and examples of the shape include polygonal shapes other than the quadrangular shape such as a triangular shape, a pentagonal shape, and a hexagonal shape, a circular shape, and an elliptical shape.

With respect to the optical component 4′ according to the embodiment, a case has been described as an example in which the functional portion is the polarizer 42. However, the functional portion is not limited to the polarizer 42. The functional portion may be set as appropriate in accordance with the application of the optical component, and may be an optical filter, an anti-reflection film, a reflective film, a phosphor, or the like, other than the polarizer 42.

Furthermore, the image display device 1 according to the present disclosure is not limited to the HUD device 1 illustrated in FIG. 1. The image display device 1 according to the present disclosure may be provided with an air blowing unit capable of blowing air against the optical component, in order to cool the optical component used as a member. Specifically, in the optical component of the present disclosure, there may be provided an air blowing unit that is capable of blowing air against the main face on which the heat dissipating portion 41 is provided. For example, when the functional portion is provided on the first main face 40a of the substrate 40 and the heat dissipating portion 41 is provided on the second main face 40b, the air blowing unit is provided so as to blow air against the second main face 40b.

Examples of the air blowing unit include a sirocco fan, and a propeller fan. Of these, the sirocco fan has a strong air feeding force, and in addition, has an air blowing direction that is different from the rotation axis direction of the fan. Thus, the degree of freedom of the installation location also increases, and thus the sirocco fan may be used.

In order to cool the optical component 4′ having a relatively small cross-sectional area of the optical path, the air blowing unit that is a tubular body may be disposed on the optical path and used. Specifically, an air blow-out portion is provided on an inner peripheral surface of the tubular body including an internal flow path, and the air blowing unit is disposed so that the image light passes through a hollow portion of the tubular body. By using such an air blowing unit that is a tubular body, for example, when the optical component is the polarizing plate 4 as illustrated in FIG. 1, a main face of the polarizing plate 4 and an opening portion of the tubular body are disposed so as to face each other. Thus, the air exiting from the opening portion is efficiently blown against the main face of the polarizing plate 4, and the main face on which the heat dissipating portion 41 is provided can be efficiently cooled without obstructing the optical path of the image light. Although the polarizing plate 4 has been described as an example, the optical components other than the polarizing plate 4 can also be cooled efficiently in a similar manner.

The image display device according to the present disclosure is not limited to the image display device 1 described above. For example, the light passing through the optical path is not limited to two-dimensional light, and may be a laser beam or the like. Examples of the optical component in this case include a laser light fluorescent plate, and a color wheel. When this mode is adopted, since an incidence area of the laser beam is relatively small (a range of the optical path is relatively narrow with respect to the area of the substrate in a plan view), the degree of freedom of design, such as the position and shape of the heat dissipating portion 41, is easily improved.

### REFERENCE SIGNS LIST

1 Image display device (HUD device)
2 Light source
3 Image forming unit
4 Polarizing plate
4′ Optical component
4a Incidence-side polarizing plate
4b Emission-side polarizing plate
40 Substrate
40a First main face
40b Second main face
41, 41′ Heat dissipating portion
42 Polarizer

1. An optical component comprising:
a substrate containing sapphire and comprising a first main face and a second main face on opposite sides from each other, wherein
an inclination of the first main face and the second main face with respect to a c-plane of the sapphire is 15° or less, and
a heat dissipating portion is provided on at least one of the first main face or the second main face.

2. The optical component according to claim 1, wherein
the heat dissipating portion is provided on the second main face, and a functional portion is provided on at least the first main face.

3. The optical component according to claim 2, wherein
the functional portion is at least one type selected from the group consisting of an optical filter that transmits or absorbs a part of incident light, an anti-reflection film, a reflective film, and a phosphor.

4. The optical component according to claim 2, wherein
a plurality of the functional portions respectively having different functions are provided, and a first functional portion having a largest calorific value among the plurality of functional portions is provided on the first main face.

5. The optical component according to claim 1, wherein
the optical component is a lens in which light is transmitted through the first main face and the second main face, and
the heat dissipating portion is provided outside an optical path on the second main face.

6. The optical component according to claim 1, wherein
the heat dissipating portion contains a nitride of aluminum.

7. An image display device comprising:
a light source; and
the optical component according to claim 1 positioned on an optical path of light emitted from the light source.

8. The image display device according to claim 7, further comprising:
an air blowing unit capable of blowing air against the main face, of the first main face and the second main face, on which the heat dissipating portion is provided.

9. The image display device according to claim 8, wherein
the air blowing unit is a sirocco fan.

10. The image display device according to claim 8, wherein
the air blowing unit is a tubular body comprising an inner peripheral surface and an air blow-out portion provided on the inner peripheral surface, and is disposed on the optical path.

11. A head-up display comprising:
the image display device according to claim 7; and
a display unit on which an image is displayed.
